(19) United States
(12) Patent Application Publication
(10) Pub. No.: US 2013/0019039 A1
(43) Pub. Date: Jan. 17, 2013

(54) SYSTEM AND METHOD FOR OPERATING A ONE-WIRE PROTOCOL SLAVE IN A TWO-WIRE PROTOCOL BUS ENVIRONMENT

(71) Applicant: Timothy James HERKLOTS, Cupertino, CA (US)

(72) Inventor: Timothy James HERKLOTS, Cupertino, CA (US)

(73) Assignee: INTERSIL AMERICAS LLC, Milpitas, CA (US)

(21) Appl. No.: 13/492,277

(22) Filed: Jun. 8, 2012

Related U.S. Application Data
(60) Provisional application No. 61/495,579, filed on Jun. 10, 2011.
(60) Provisional application No. 61/616,723, filed on Mar. 28, 2012.

(51) Int. Cl. G06F 13/42

(52) U.S. Cl. 710/105

(57) ABSTRACT

A method for transmitting data on a data line of a two-wire bus wherein the bus includes a data line and a clock line includes the step of pulling the data line of the two-wire bus low to define a start condition. Next, a first group of fixed data bits enabling a slave device to determine a clock signal for an address portion of a transmission of data are transmitted between a master device and the slave device. An address of the slave device is transmitted from the master device in a second group of data bits. A third group of fixed data bits enabling the slave device to determine the clock signal for a data portion of the transmission of data between the master device and the slave device are transmitted from the master device to the slave device.

### CROSS-REFERENCE TO RELATED APPLICATIONS

This application claims priority to U.S. Provisional Application No. 61/495,579, filed Jun. 10, 2011, entitled 1-WIRE BUS WHICH IS DROP-IN COMPATIBLE WITH I²C TRANSMISSIONS, the specification of which is incorporated herein by reference.

### BRIEF DESCRIPTION OF THE DRAWINGS

For a more complete understanding, reference is now made to the following description taken in conjunction with the accompanying Drawings in which:

FIG. 1A illustrates a master device and multiple slave devices that may communicate over an I²C bus in either a two-wire communications mode or a one-wire communications mode;

FIG. 1B illustrates a configuration of a device capable of communicating over an I²C bus using either a two-wire communications mode or a one-wire communications mode;

FIG. 2 illustrates the format for transmitting one-wire communication over an I²C bus;

FIGS. 2A and 2B illustrate further diagrams of the bit sequence;

FIG. 3 illustrates the format for transmission of a slave address using asynchronous communications over an I²C communications bus;

FIG. 4A illustrates the configuration of a Write byte version of FIG. 3;

FIG. 4B illustrates the configuration of a Read byte version of FIG. 3;

FIG. 5 illustrates a signal associated with a one-wire transmission protocol over an I²C bus configuration in both a Write mode and a Read mode;

FIG. 5A illustrates a timing diagram for the acknowledge timing;

FIG. 6 is a flow diagram illustrating the manner for transmitting one-wire communications over an I²C bus;

FIG. 7 is a flow chart illustrating the manner for detecting the one-wire communications over an I²C bus;

FIG. 8 illustrates the manner for generating a clock signal from an asynchronous one-wire communications received on the I²C bus;

FIG. 9 illustrates a system configuration wherein both I²C devices and one-wire communication devices may communicate over a single I²C bus;

FIG. 10 is a flow diagram illustrating the manner for controlling both I²C devices and one-wire devices communicating over a single I²C bus;

FIGS. 11A and 11B illustrate chip configurations for the one-wire and two-wire mode slave devices; and

FIGS. 12A and 12B illustrate address maps for the one-wire embodiment network.

### DETAILED DESCRIPTION

Referring now to the drawings, wherein like reference numbers are used herein to designate like elements throughout, the various views and embodiments of a system and method for operating a two-wire bus using a two-wire protocol and a one-wire protocol are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

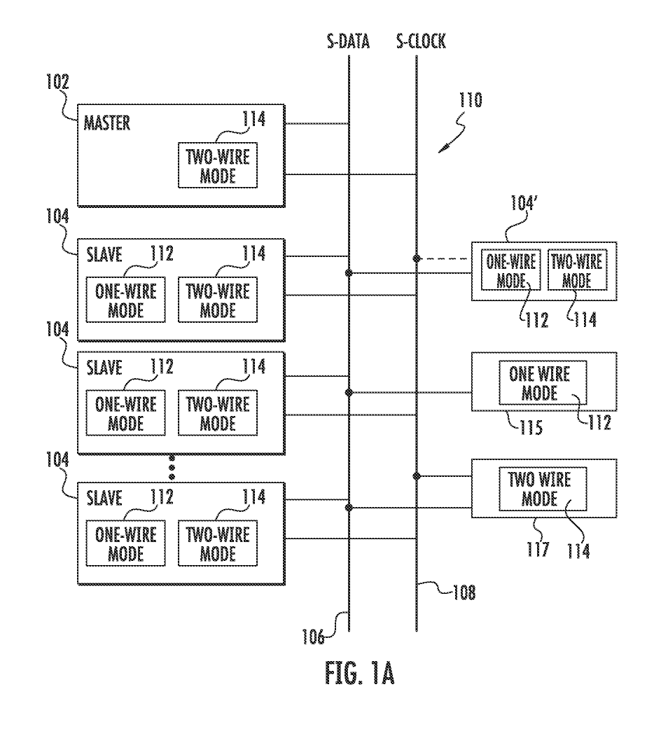

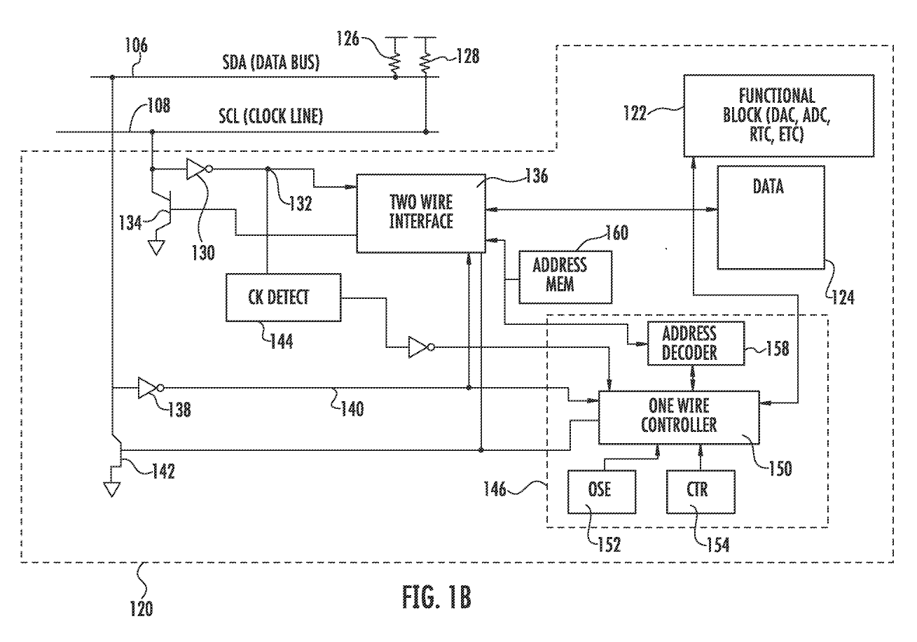

Referring now to the drawings, and more particularly to FIG. 1A, there is illustrated a master device, 102 and a plurality of slave devices, 104. Each of the master device 102 and slave devices 104 are connected to an I²C bus consisting of an S-data (SDA) line 106 and S-clock (SCL) line 108. The S-data line 106 carries the data and address information that is transmitted between the master device 102 and slave devices 104 as well as acknowledgement signals. The S-clock line 108 carries the clock signal for providing timing information to enable synchronous communications between the master device 102 and slave devices 104. While the present description is made with respect to an I²C two-wire protocol other types of two-wire buses may be used. A two-wire bus protocol is a protocol that provides one-wire for data and one-wire for timing information to allow for synchronizing of data transmission between a transmitting node on the bus and a receiving node.

By utilizing a one-wire protocol operating within the normal constraints of the I²C communications protocol, devices connected to the I²C communication bus 110 consisting of the S-data line 106 and S-clock line 108 may communicate over the I²C bus 110 using the two-wire I²C protocol with either a one-wire communication mode interface 112 requiring only the S-data line 106 or a two-wire communication mode interface 114 using both the S-data line 106 and S-clock line 108. While each of the master device 102 and slave devices 104 of FIG. 1A illustrate devices having both a one-wire communication mode interface 112 and a two-wire communications mode interface 114, it is also possible that each of the devices can communicate using only the two-wire communications mode interface 114 or the one-wire communications mode interface 112 incorporating the protocol described herein. The master device 102 only has the two-wire communications mode interface 114.

The two-wire communications mode interface 114 enables an attached device to operate over the I²C bus 110 using a synchronous communications mode of operation. While the present description is described with respect to the use of an I²C communications bus with a two-wire communications mode, other types of two-wire communications protocols with broadly similar signaling, may also be utilized such as SMBus or PMBus, for example. The one-wire communications mode interface 112 of each of the devices enables the use of a I²C bus having a synchronous protocol but using an asynchronous interface therewith.

With further reference to FIG. 1A, three slave devices 104 and one master device 102 are illustrated on the left side of the bus the I²C bus 110. Each of these devices, the master, 102 and the slaves, 104, both have a clock input and a data input/output connected to the clock line 108 and the data line 106, respectively. Also, illustrated on the right side of the bus are three additional modules. The first module is a slave device 104′. This is identical to the devices 104 on the left side of the bus with the exception that the inter connectivity is illustrated as only having a connection to the S-data line 106, i.e., there is no clock connection. This clock connection is illustrated with a phantom line to illustrate that no clock mode is connected, even though there is a pin available for it, such that it can operate in the two-wire mode. This slave device 104′, as with the slave devices 104, have both the one-wire communications mode interface 112 and the two-wire communications mode interface 114. However, since the clock signal is not available, the two-wire communications mode interface 114 will not be utilized. In addition, there is illustrated a slave device 115 which has only a one-wire communications mode interface 112 associated therewith. This slave device 115 is only connected to the S-data line 106 such that it can only receive/transmit data. There is also provided a slave device 117, which is connected to both the S-data line 106 and the S-clock line 108 and this slave device has only a two-wire communications mode interface 114 associated therewith. The module 117 is a dedicated two-wire communication slave such that it must have the clock line in order to operate. By comparison, the slave device 115 is not capable of receiving the S-clock line 108, and, therefore, it is always operating in the one-wire mode. As will be described further hereinbelow, deletion of the requirement for a clock input allows one fewer pin to be dedicated to the serial port interface. Even though this slave 115, for example, only has a one-wire communications mode interface 112, it can be “dropped in” the place of any of the slave devices 104 and, the master 102 need not be aware of what mode of operation any particular slave device is operating in, i.e., master 102 assumes all slave devices are operating in a mode of operation that allows for synchronous communication in accordance with the I²C communication protocol, even though the data communication for the one-wire mode of communication is actually asynchronous.

The general overall operation of the I²C protocol is for the master 102 to generate a start bit, followed by a 7-bit or a 10-bit address to uniquely address one of the slaves. Each of the slave devices in a system normally has a unique address. Following the 7-bit or 10-bit address will be a single direction bit to determine whether this is a Read or a Write operation. Once the address and the direction bit have been read by the slave, a 1-bit field is provided to allow the slave to generate an acknowledge bit. The acknowledge bit is always generated by the receiving device such that, for a Read operation, an acknowledge bit will be generated by the master after it has received data from the slave.

From a communication stand point, the master 102 will treat every slave on the bus 110 equally; that is, it will generate an address and a clock signal regardless of whether a particular slave is operating in the one-wire mode or the two-wire mode because it cannot distinguish one-wire from two-wire. Thus, that particular slave, when operating in a one-wire mode, must be able to receive and transmit to the data bus as if it were in a synchronous mode of operation.

Referring now to FIG. 1B, there is illustrated a functional block diagram of a device capable of communicating over a two-wire communication bus, such as an I²C bus in either a two-wire mode of operation or a one-wire mode of operation. The device is generally referred to by the reference numeral 120. The device 120 includes a functional block 122, which functional block 122 basically provides the functional identity of the device. In serial bus systems, slave devices are typically some device that is utilized as a sensor, as a data collection device or as a data transmission device. For example, the slave device could be a digital-analog-converter (DAC), an analog-to-digital converter (ADC) or Real Time Clock (RTC). Each of these devices, as described hereinabove, normally has a unique bus address associated therewith. Thus, if a master, typically realized with a microcontroller unit (MCU), desires to transmit information to a slave device for the purpose of generating an analog signal, it might select a DAC slave device and transmit digital data thereto for conversion to analog data and for output therefrom. All that is required is addressing the device and transmitting data thereto. Once the data is transferred to the device, it performs its associated functionality. The functional block 122 interfaces with an onboard memory 124 which is accessible via the two-wire or one-wire interfaces.

In order to interface with the data bus 106 (SDLA) or the clock line 108 (SCL), there are provided selected interfaces for both. Since this is a bidirectional data and clock lines, i.e., both the master and the slave can control the line, each has the ability to detect a low going signal or drive the line low, this being an open collector configuration with pull-up resistors 126 and 128, respectfully, associated with the respective SDA line 106 and SCL line 108. For the clock line, there is provided a receive buffer 130 for receiving the clock signal and providing its output on a line 132 and also an NPN transistor 134 with the collector thereof connected to the SCL line 108 and the emitter thereof connected to ground. The clock line 132 will interface, in a two-wire mode, with a conventional two-wire interface 136. The two-wire interface 136 will receive the clock signal on the line 132 and derive its timing therefrom. For data transfer and for control of the SCL line 108 for some function such as clock stretching, the transistor 134 is controlled by the two-wire interface 136 to pull the SCL line 108 low by the slave. For data reception and data transfer, a buffer 138 is provided which is connected on one side to the SDA line 106 to provide a data output signal on line 140. To transmit data from the slave, an NPN transistor 142 having it emitter thereof connected to ground and the collector thereof connected to the SDA line 106 is provided with the base thereof controlled by the two-wire interface 136.

In operation, whenever the SDA line 106 is detected as going low on the line 140 by the two-wire interface 136 while the clock line 108 is high and then the clock line is detected as going low at a later time, this will indicate to the two-wire interface 136 the occurrence of a start signal for a two-wire communication. If the clock signal never goes low, i.e., because there is no clock signal attached, then this indicates a one-wire configuration wherein the SDA line 106 going low comprises the start signal. Of course, for this chip, there will be a requirement that the SCL line 108 input is pulled high at all times when in the one-wire mode. Thus, if a chip with a two-wire interface is placed into a one-wire system, i.e., a system without a clock line, it is necessary to pull that input high. However, if a clock is present on the SCL input, the two-wire interface 136 in the two-wire mode will be able to receive data and then transmit the data since it receives both input from the buffer 138 and is able to control the base of the transistor 142.

In the one-wire mode, a clock detect circuit 144 is provided to determine whether the clock line has gone low. If the data line goes low and the clock line does not go low, a one-wire interface 146 will then take control of the communication. When the data line goes low on line 140, the one-wire interface 146, as well as the two-wire interface 136, are both initiated. However, if a clock signal is detected, the one-wire interface 146 will be disabled, i.e., it will know that no information is to be transmitted thereto. This is only in the case where there is provided on the chip a two-wire interface and a one-wire interface function. If only a one-wire interface were provided, the one-wire interface 146 would always asynchronously decode the received address. The SCL pin is tied to open to indicate a one-wire mode.

The one-wire interface 146 contains a one-wire controller 150 and a free running oscillator 152, which is not synchronized with the master or with the clock signal on the SCL line 108. There is also provided a counter 154 which is operable to count the number of cycles of the oscillator 152 between successive edges of a data input during a synch operation. An address decoder 158 is provided which is operable to access an address memory 160 to compare the received address bits, decode those address bits and compare them to what is stored in the address memory 160. This address memory 160 is also utilized for the two-wire interface function 136. This address memory 160 provides the address for the device 120. As will be described hereinbelow, for a two-wire interface functionality, only a single unique address is provided for the device 120. In the instantiation described hereinbelow, the one-wire interface portion 146 mode requires two addresses, one for Write operation and one for Read operation. Thus, when the slave is synchronized and the address bits are extracted from the data stream, the address will determine whether data is to be transferred thereto or read therefrom. If a particular slave is bidirectional (R/W capable) this will require the master device 102 to view a particular slave device as actually two slave devices on the system, one for a data transmission operation and one for a data fetch operation.

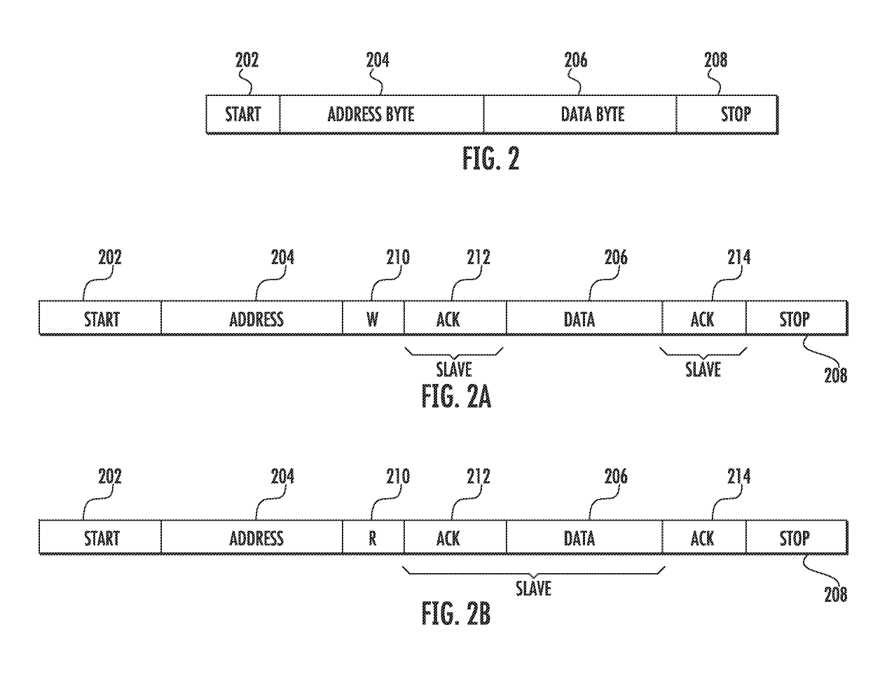

Referring now to FIG. 2, there is illustrated the format of data transmissions between a master device 102 (FIG. 1A) and a slave device 104 (FIG. 1A) using the asynchronous one-wire communications protocol of the present disclosure. The data format of the protocol includes the detection of a start condition in a field 202 on the S-data line 106 of the I²C communications bus 110. After the start condition in field 202, an address byte in a field 204 is transmitted including information enabling the generation of a clock signal and extraction of the address of the slave device with which the associated Read/Write operation is to be performed. After the address byte in field 204, a data byte in a field 206 is transmitted. The data byte in field 206 comprises the Read or Write information that is provided to/from the master device. After the data byte in field 206, a stop condition in field 208 is providing indicating the end of the Read/Write operation on the I²C bus 110.

Referring now to FIGS. 2A and 2B, there is illustrated a more detailed diagram of the instruction sequence from the master to the slave and from the slave to the master. FIG. 2A illustrates the instruction sequence from the master to the slave for transferring data thereto. This shows the start bit 202 followed by the address bits 204 followed by the Write (direction) bit, in a field 210. This is a single bit for direction. This is generated by the master. The address 204 and the Write bit 210, in the 7-bit I²C address scheme, comprise a control byte for the operation. Thereafter, an acknowledgement bit (ACK) in a field 212 is generated by the slave followed by a data byte in a field 206 generated by the master. The slave then generates an ACK bit in a field 214 followed by the stop bit 208 generated by the master. In FIG. 2B, the start bit 202 is generated followed by a 7-bit address field 204 and then a Read bit in a field 210 is generated. This is all generated by the master, the address bits in field 204 and the Read bit in field 210 comprised a control byte from the master. In a Read operation, this will be followed by an ACK in field 212 and then data in field 206 from the slave to the master. The ACK bit 214 is generated by the master in a Read operation as compared to the slave in a Write operation. This is followed by the stop bit in field 208.

Since the slave in a one-wire environment cannot receive a clock signal, the I²C protocol will not afford multiple data bytes to be transferred. Cumulative error will prevent this. In a conventional I²C protocol, the slave, after the ACK bit 214, can continue to transfer or receive data, depending upon the direction bit in field 210, if the stop bit has not been generated, which stop bit is a condition wherein the SDA line 106 makes a transition from a low to a high while the SCL line 108 is high. Thus, the SCL line 108 is pulled high before the SDA line is pulled high. Since the SCL line 108 is not available, this requires that the slave be able to detect the transition of the data line at a particular time relative to a predicted clock occurance and thus allow multiple bytes to be transmitted for either a Read or a Write operation.

Referring now also to FIG. 3, there is more fully illustrated the format of the address byte in field 204 that is used to both indicate the address of the slave device with which the master device is communicating and provide the ability to internally generate a clock signal for the asynchronous communications over the I²C bus. The address byte in field 204 includes a preamble 302. The preamble 302 always comprises a one-bit followed by a zero-bit that enables synchronization of the transmission. This process will be more fully described herein below. The next portion of the address byte in field 204 comprises an address field 304 comprising a three-bit address enabling the addressing of up to eight different slave devices connected to the I²C bus 110. Each of the slave devices are independently addressable using the three-bit address portion 304. A post amble 306 provides an indication of either a Read operation using the bit combination “101” or a Write operation using the bit combination “010”.

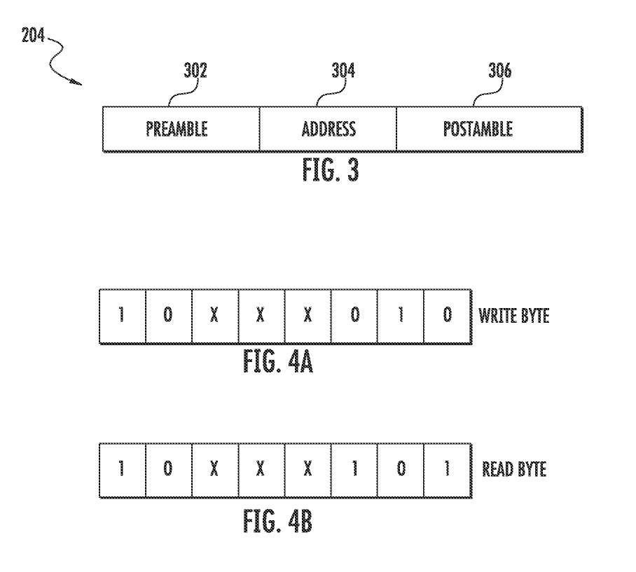

The above-described slave addressable format provides for separate Read and Write addresses as illustrated in FIGS. 4A and 4B, respectively. FIG. 4A illustrates a Write addressable slave address including the “10” preamble, the three address bits (indicated generally with XXX) indicating the independently addressable slave device and the Write-specific post-amble consisting of the bits “010”. Similarly, a Read addressable slave location is indicated in FIG. 4B. This includes the two-bit preamble consisting of “10”, the three variable bits for the eight independently addressable slave devices and the post-amble, including the read indication bit combination “101”.

By forcing constraints on the allowable slave address ranges using the preamble 302 and post-amble 306, the protocol for the one-wire asynchronous communications may re-synthesize the rising edge of the S-clock signal in order to enable correct sampling of the S-data line 106. Thus, using the described scheme, the S-data line 106 is forced to provide the fixed preamble 302 to enable the generation of data timing at the beginning of every data transmission following the start condition 202. The use of the fixed post-amble 306 for a Read or Write operation on the s-data line 106 enables resynchronization of the system timing for the subsequent data byte field 206.

The preamble 302 and the post amble 306 in FIG. 3 are basically synch bits. The preamble 302 is utilized to initially synchronize the local or internal slave clock, which is a free running clock, to the data. In essence, timing information is extracted from the received data stream. Once the clock is synchronized, then following address bits in the I²C address field can be extracted. Thereafter, additional synch bits are provided in the postamble 306 wherein the I²C address field which precedes the data byte field 206. This is for the purpose of once again providing an adjustment to the clock, if necessary. With respect to the addresses, a conventional I²C protocol sets the address field 204 for a 7-bit address. By ensuring that there is a logic “10” bit value for the upper 2 MSBs, the slave will be ensured to receive a leading edge and a falling edge prior to the first address bit. By counting the number of clock cycles between these two edges, the length of a clock cycle for the internal slave clock can be determined and utilized to determine the sampling point for follow on bits. If the clocks were sufficiently stable between the master and the slave, further synchronization would not be required. However, to account for drift and the such between clocks, an additional guaranteed leading and falling edge will be provided in the post amble 306. This will be described in more detail hereinbelow.

For synchronization purposes, it is necessary to have somewhere within the address field two successive edges, a rising edge and a falling edge or, alternatively, a falling edge and a rising edge. From this information, the length of the SCL clock signal can be determined. Therefore, in the data stream, a “101” or a “010” must exist. In the disclosed embodiment, this is facilitated in the beginning of the clock cycle since the data line is pulled low followed by the address. Thus, there will be a “0” prior to the initiation of the 7-bit I²C address field. However, the length of time between the falling edge of data stream on the SDA line 106 indicating the initiation of a data transmission and beginning the of the I²C address field is not measured in terms of a single “bit time.” Rather, all that is ensured is that there will be a data low condition prior to the initiation of the I²C address field. By ensuring that the first bit in the address is a one, that will ensure that there is a first rising edge and then ensure that the next bit is a “0” will ensure a falling edge and this will enable measurement of time between two successive edges for a “010” condition. Note that, by placing this at the beginning of the address field, one fewer defined bit is required due to the fact that there is a known condition of the data low prior to initiation of the address. Thus, by fixing these two MSBs to a “10” state, only two bits are required for the synchronization process. These, of course, could be disposed within the middle of the I²C address field, and then all edges analyzed in the received signal. In the case where a second synchronizing operation is required prior to the data, there will be required three bits of address. This is the reason that for the Write operation and the Read operation requires a “010” or a “101” sequence, respectively. Thus, by providing a standard I²C address field (7-bit or 10-bit) followed by the direction bit and by ensuring that there are two successive rising/falling or falling/rising edges in the address field at some point therein, clock information can be extracted from the address field. This does not require additional synchronizing bits to be transmitted by the master prior to generating an I²C address field because, as stated hereinabove, the master has no knowledge that any portion of the I²C address is utilized for synchronizing purposes. It merely requests the master to generate the unique slave address that was fixed in its memory for that particular slave device in the course of the standard I²C protocol. It is the slave device to which the communication is directed that understands how to extract the 3-bit address and the timing information from the I²C address field, with the additional notation that the address space must be restricted. Thus, all addresses on the bus have a common “10” for the first two MSBs. But this restriction is merely between the devices that are attached to an I²C bus in which at least one of the devices operates in a one-wire mode of operation and only receives data and not clock information.

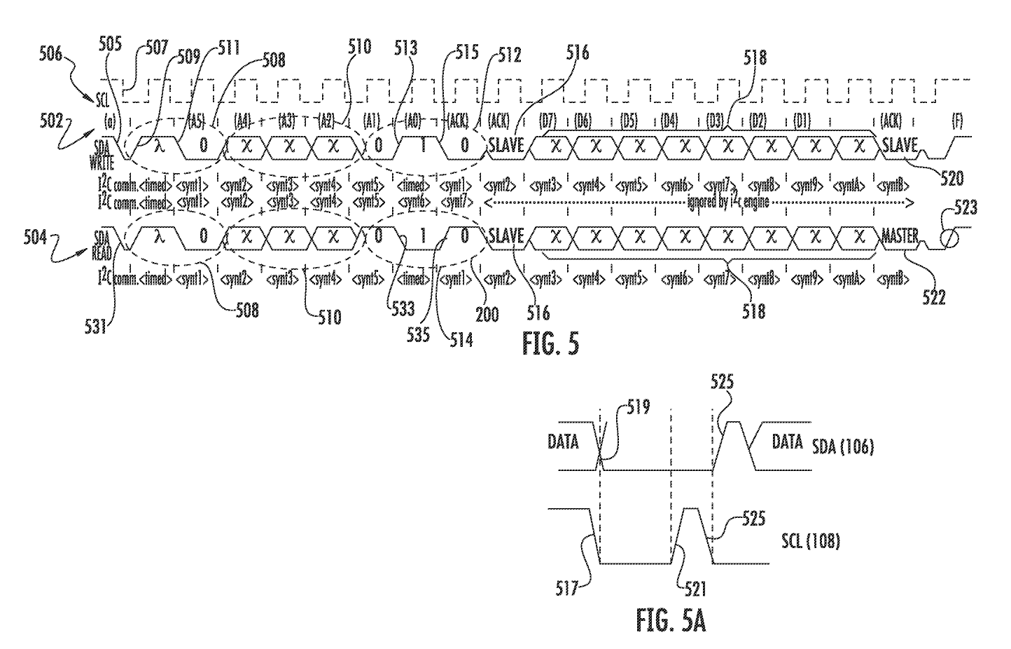

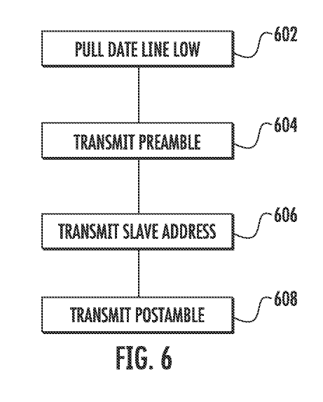

Referring now to FIG. 5, there is illustrated a data stream associated with a Write operation and a Read operation in the one-wire mode of operation. A data stream 502 is illustrated for the Write operation and a data stream 504 is illustrated for a Read operation. Each of these data streams provides the address followed by a data field which, for the Write operation, transfers data to the slave and, for Read operation, receives data from the slave. A slave generated clock waveform 504 is illustrated which represents a reconstructed and synchronized clock which is synchronized locally from the timing information extracted from the address field of the data stream, as described hereinabove.

With respect to the Write data stream 502, this will be described initially. The data transfer operation is initiated by the SDA 106 falling low at an edge 505. This basically wakes the part up and indicates that the data transfer operation is to begin. The normal mode of operation with a clock line connected to the part in a normal two-wire I²C mode of operation and a clock line utilized for the data transfer would require a falling edge of the SCL 108 to occur after the falling edge 505. This is illustrated by an edge 507 of the regenerated local clock. Although this locally generated clock is illustrated as being accurate in time, it is not actually synchronized at this point in time. However, the falling edge 505 and the falling edge 507, in a normal two-wire mode of operation I²C format, would constitute the start bit. Since this is a one-wire transfer operation, only the falling edge 505 constitutes the start bit.

Once the falling edge 505 occurs, the system is initiated from a control stand point and awaits a next rising edge 509. This rising edge 509 occurs after the clock edge 507 and initiates a counter. A counter will count the number of cycles of a local oscillator (with higher frequency than the clock waveform 506) until the next falling edge 511. This is the reason that the first bit in the normal address field for the I²C protocol must be a “1” followed by “0.” Once the falling edge 511 occurs, timing information has been extracted from the sequence. Of course, this requires that a “0” be the next occurring bit after the MSB and this is a fixed requirement. Thus, the first two bits of the address, the first two MSBs, are dedicated to the synch field operation but, from the perspective of the master, this is still a slave address. This is illustrated with a circle 508 about these two bits.

Once the clock has been synchronized, then it is possible to ensure that the leading edge of the clock occurs at the appropriate bit position within a particular bit time. Thus, the next three address bits, A2, A3 and A4 can be read, this being in a region 510 in the bit stream. These constitute the slave addresses that are allowable with respect to the one-wire protocol. This will allow for eight different slaves to the addressed. Of course, it should be understood, that long address fields can be used in the initial protocol, such as for a 10-bit I²C protocol. It is only necessary that the first two bits be utilized for the synchronization operation and the last two bits be utilized for the subsequent post amble synch operation. In the Write operation, this is illustrated as being the bit sequence “010” which comprises the R/W bit in the two LSBs bits, a “0” and a “1”. Since the Write bit in the I²C protocol is required to be a “0,” then, in order to provide a synchronizing edge, the preceding two bits must be a “0” and a “1.” Thus, after the three address bits are read in the field 510, the first bit to be read will be a “0” for a Write operation. At this point in time, the one-wire interface interprets this as being a Write operation and then, at the next leading edge 513, starts the counter again until the next falling edge 515. This provides a refresh of the SCL clock cycle length and is utilized to adjust the internal bit clock, if necessary.

After the two LSBs and the R/W bit are read in the field 512, the next bit time is reserved for the acknowledgement signal, this being a field 516. This is one in which the slave generates the signal for transmission back to the master by pulling the SDA line 106 low. The detail of this is illustrated in FIG. 5A which is illustrated for a conventional I²C protocol. The conventional method is that an acknowledgement is initiated after the SCL line 108 is pulled low by the master at an edge 517 (this not being seen by a one-wire device). The slave is supposed to pull the SDA line 106 low at a point 519. Thereafter, the master will pull the SCL line 108 high again at an edge 521 and then low at an edge 523. The slave senses this and then releases the SDA line 106 at an edge 525. Of course, since the slave cannot see the SCL line 108, the slave must make the assumption that the SCL line has been pulled low at a point 517 and then the slave pulls the SDA line 106 low at a point 519 which may be delayed to ensure that the master will see such occur. Then a predetermined amount of time is counted which should be a half cycle of the clock and then the slave again allows the SDA line 106 to go high at a point 525. All that is required by the master is that the SDA line 106 be pulled low for the time between edges 517 and edge 521. Of course, edge 521 will not occur until the SDA line 106 is pulled high.

After the SDA line is pulled high during ACK bit 516, then one byte of data is transmitted by the master. The resynchronized clock can now sample each of these bits at the appropriate point until the end of a field 518. At the end of the field 518, the SDA line 106 will be pulled low for another acknowledgement bit 520. This is performed by the slave device in accordance with the timing diagram described hereinabove with respect to FIG. 5A. Since a conventional stop bit for an I²C protocol would require the slave device to sense both that the clock line remained high when the data line again went high, this would require the slave device to sense within the next sample time that that a “transition” had occurred on the data line from a “low” to a “high” during a time when data should be static. This transition generated by the master on the data line occurs during the time that the clock is expected to be high and that the data is expected to be static at the transition 523.

The Read operation associated with the Read bit stream 504 is similar to that of the Write bit stream 502. It will be provided a falling data edge 531 from the master followed by the logic “10” bit sequence in a field 508 within the I²C address field for the synchronizing operation, followed by the three address bits in the field 510 within the I²C address field and then the sequence “101” for the Read sequence. In this sequence, the slave will sense the address bit Al and determine that it is at a logic level “1” which will indicate a Read operation. Even though the slave is aware there is a Read operation, it will then look for the next falling edge, falling edge 533, followed by rising edge 535 and use this to synchronize. This is the reason that there must be a “1” followed by a “0” followed by a “1.” Thereafter, an acknowledgement signal will be sent back in a field 516 followed by one byte of data in the field 518. Since this is a Read operation, the one byte of data is transferred from the slave to the master. Thus, at the end of the last byte of data in a field 518, there must be an acknowledgement received from the master in a field 522. In a field 522, the acknowledge from the master to the slave is slightly different in that the slave, after transmission of the last bit to the master, will then release the SDA line 106. The SDA line 106 goes high and then the master will pull the SDA line 106 low. The slave can see this operation. The master then places a clock pulse on the SCL line 108 and, after end of this pulse, releases the SDA line. What the slave will see is the SDA 106 go low and then high but will not see the clock pulse.

In generating the signals according to the described protocol, a number of presumptions are made that force the interface to operate in a manner that most users operate the I²C protocol, but allow the operation of a one-wire protocol. These presumptions include the S-data rise/fail times must be relatively close together since the S-clock period is measured from rise to fall. Additionally, the S-clock period does not accumulate an error (i.e., grow or shrink) during transmission between the start portion and the stop portion. Also, the delay from the S-clock falling edge to the S-data rising or falling edge is consistent and small (under 15 percent of the S-clock period). A minimum S-clock speed of 1 kilohertz is assumed to constrain the length of the counter used for a clock period measurement. Thus, using the above described technique, the S-clock timing may be determined by limiting the range of 256 read/write slave addresses to a few addresses that simplify the timing extraction. The process utilizes the falling edge of the S-data signal as the beginning of a one-wire communication.

Referring to FIG. 6, there is illustrated the manner in which information may be transmitted over an I²C or two-wire bus utilizing the one-wire protocol described herein. The S-clock line 108 and S-data line 106 of the I²C bus are both initially pulled high by pull up resistors and the S-data line is actively pulled low at step 602 to provide an indication of the start of the data transmission.

Next, the preamble consisting of the combination of the one bit and zero bit are transmitted at the step 604 as part of the I²C address field to enable initial synchronization of the asynchronous one-wire transmission for the slave address. The slave device address is then transmitted at step 606 from the master device over the I²C bus as part of the I²C address field to notify the slave device for which the data is addressed. Finally, the post-amble for either the Write or Read operation is transmitted at step 608 as part of the I²C address filed in addition to the direction bit to enable resynchronization for transmission of the data byte following the transmission of the address byte.

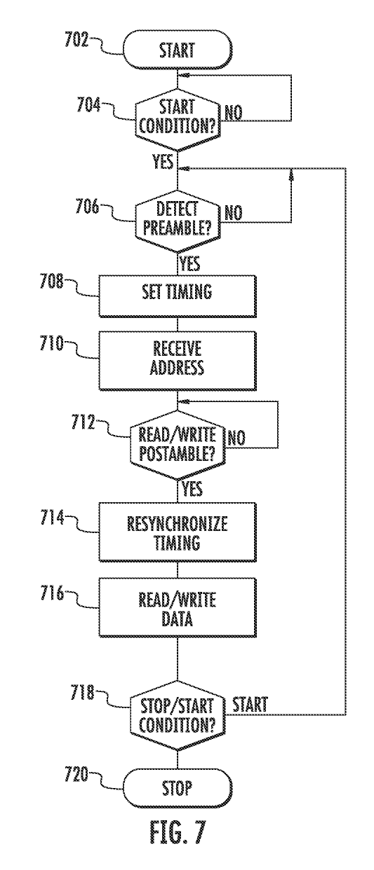

Referring now to FIG. 7, there is illustrated the manner in which the slave devices monitor the I²C bus in order to detect the transmission of information on the S-data line 106 that was transmitted using the an I²C or two-wire protocol but processed utilizing the one-wire protocol. The process begins at step 702 and the slave devices on the I²C bus all monitor for the occurrence of a start condition at step 704 when the S-data line is pulled low. If no start condition is detected, the slave devices continue monitoring for a start condition, and upon detection of the start condition, the slave devices begin monitoring for the preamble comprising the one-bit and zero bit at inquiry step 706.

Once the preamble is detected, the timing for the address byte is established at step 708. The address associated with the addressable slave device is detected at step 710. After receipt of the address, the addressed slave device begins monitoring for the Read/Write post amble at inquiry step 712. Once the Read/Write post amble is detected at inquiry step 712, the timing is resynchronized at step 714 at the slave device for receipt of the data byte. The Read/Write data is transmitted over the I²C bus at step 716 in the appropriate direction, and a stop indication or a further start indication is detected at inquiry step 718, i.e., the end of the last bit of data. Upon determining that the last bit of data has been transmitted indicating a stop condition, the process is ended at step 720. If an additional start condition is provided, the process returns to inquiry step 706 to monitor for a new preamble.

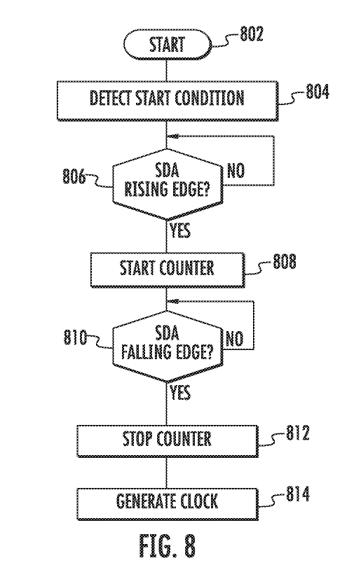

The process for generating the timing signal for the address byte at step 708 or re-synchronizing the timing for the receipt of the data information at step 714 is more fully described with respect to the flow chart of FIG. 8. This process utilizes a counter and clock circuit within the devices monitoring the I²C bus in order to enable them to establish timing for the received asynchronous signal on the S-data line. The process is initiated as step 802, and the devices monitor for the occurrence of a start condition at inquiry step 804 when the S-data line is pulled low. After detection of the start condition, the slave devices monitor at inquiry step 806 for the occurrence of a rising edge on the S-data line. This is represented by the transmission of the one-bit within the preamble.

Upon detection of the rising edge at inquiry step 806, a counter within the detecting device is initiated at step 808. The device will then monitor at inquiry step 810 for the occurrence of a falling edge on the S-data line represented by the transmission of the next zero bit of the preamble. Upon detection of the falling edge on the S-data line, the counter is stopped at step 812. Utilizing the information within the counter and the known period of an internal clock, the S-clock signal may be generated for the transmissions at step 814. Using the internal clock and counter, the period of the S-clock may be determined from the rising edge of the S-data line and the falling edge of the S-data line since the one and zero bits are always transmitted as part of the preamble. One manner for synthesizing the S-clock signal is to run an internal high-speed clock oscillator having a much faster rate than the maximum S-clock signal that is expected. The counter then counts the number of periods of this clock that occur between the detected rising edge of the S-data line and the falling edge of the S-data line within the preamble. For low-power systems, the oscillator could be enabled upon the first falling edge of the S-data line providing a minimum of 600 nanoseconds to stabilize before the first rising edge of the S-data line. The oscillator may then be disabled outside of transmissions in order to save power.

The determination of the clock period for transmission of the data byte is determined in a similar manner responsive to the known rising and falling edges of the transmitted post-amble. Within the post-amble, the first bit of the post-amble indicates a Write operation or Read operation with the zero bit indicating a Write operation and a one bit indicating a Read operation. The last two one/zero bits of the Write post-amble may then be used to establish the timing for the data bit in the same manner that the one and zero bits of the preamble are used as described hereinabove. For a Read operation, the process works in a similar manner to that described with respect to the preamble but in an initial detection, and starting of the counter is made upon the detection of the falling edge of the zero bit and then the counter is stopped upon the rising edge of the one bit. The counter value and the known period of the clock is then used to determine the clock signal in a similar manner.

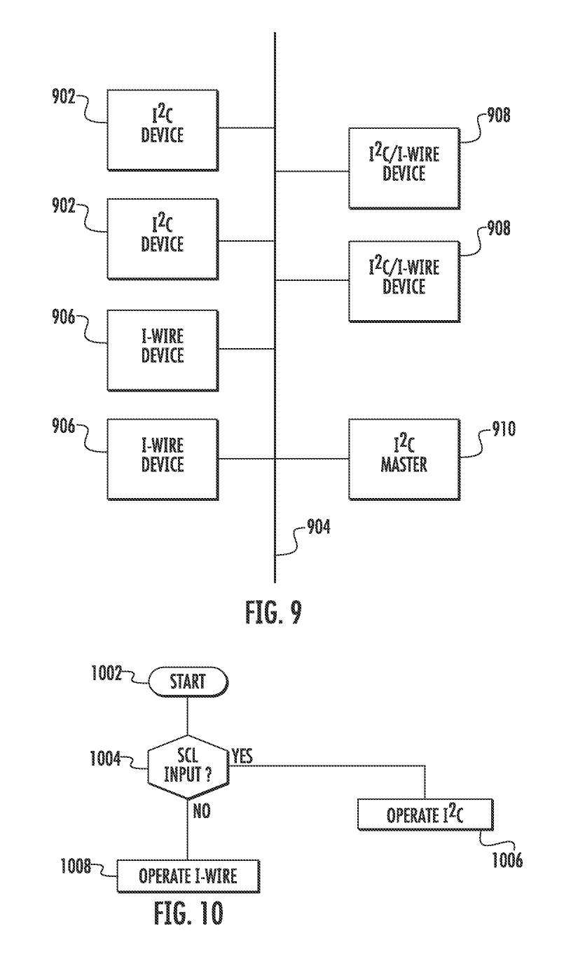

Referring now to FIG. 9, there are illustrated the benefits provided by the use of the one-wire protocol within a two-wire (I²C) bus configuration (both clock and data). I²C devices 902 may connect to the I²C bus 904 and carry out communications over the I²C bus in a known fashion. Additionally, one-wire devices 906 operating according to the above described one-wire protocol can be connected over the same I²C bus. Thus, both types of devices may communicate over the I²C bus using their different protocols.

Referring further to FIG. 9, the bus 904 is an I²C bus and, as such, it has both a clock line and a data line. An I²C master 910 is provided and connected to the bus 904. The master 910 is typically realized with some type of process based device such as an MCU. From the perspective of the master 910, all devices connected to the bus have a unique ID (address) and can communicate with the I²C protocol, i.e., the master 910 assumes that all communications are synchronous and that the clock generated for output on the clock portion of the bus 904 will be used to synchronize data transferred. From the perspective of the two I²C devices 902 that are illustrated as being connected to the bus, this is truly a synchronous communication. With respect to the two I²C/one-wire devices 908, this depends upon on whether the clock line is connected. This may be the case where, for example, only a single wire connection is available or only a single wire was bonded out in the packaged device, as will be described hereinbelow. From the perspective of the two one-wire devices 906, these devices do not have a clock line input and, as such, they cannot receive the clock. However, they must communicate with the master 910 as if they were a true I²C device communicating in a synchronous manner. Thus, it can be seen that the one-wire devices 906 can be dropped into an I²C environment, extract timing information from the data line and communicate with the master 910 without requiring any special treatment by the master 910—all they need is a unique address on the bus 904 from the perspective of the master.

Referring now also to FIG. 10, there is illustrated the manner in which both I²C devices and one-wire devices may share a single I²C bus utilizing the above described protocol. After initiation of communication at step 1002 by master 910, inquiry step 1004 determines whether an input is being received on the S-clock line. If a clock signal is detected on the S-clock line, the slave device is both operating according to the I²C protocol and communications are carried out utilizing the I²C protocol at step 1006 if the device can operate in that mode. If inquiry step 1004 determines that no S-clock input is being received, the communications are being carried out using the above-described one-wire protocol and the device operates according to the one-wire protocol at step 1008, (noting that none of the I²C devices 902 can operate with the one-wire protocol).

Thus, using the above described system and method, communications may be carried out over a synchronous I²C bus using a synchronous two-wire I²C protocol with slave devices operating using an asynchronous one-wire protocol. The I²C signaling system remains unaltered, enabling existing hardware and software methods for generating I²C communications to continue to be used. By applying signals on the S-data line of the I²C bus including the above-described constraints, a mix of conventional I²C/SMBus devices and devices using the one-wire protocol as described herein may share the same bus.

As described above, each device on the bus must be individually addressed, i.e., each must possess a unique address with respect to its position on the I²C bus. If a seven bit address is utilized with a direction bit, this provides a total of eight bits which, as described hereinabove, are divided up such that three bits are true address bits uniquely identifying a device, the first two MSBs used for synchronizing the data portion and the last three LSBs utilized for the direction and for resynchronizing the one-wire slave for a data transfer. The second synchronization may not be necessary which may allow two additional bits to be provided for an address with a single direction bit. This would then provide for 32 unique addresses. However, in this situation, there would only be required a single address for a particular one-wire device for both the Read and the Write operations since the unique address is defined apart from the direction bit. This is compared to the first embodiment that required the post amble synchronization wherein the unique address plus direction bits generated by the master would have to take into account the synchronization aspect and, as such, two addresses would be required for each part, assuming that a particular part required both a Read and a Write operation. This may not be the case with respect to some parts that are unidirectional such as a DAC and an ADC.

If a 7-bit address I²C protocol were utilized with a single direction bit for either a preamble/post amble synchronization process or only a preamble synchronization process, the first two bits with a “10” logic state would have to be present for all devices, including the two synchronous I²C devices 902. The reason for this is that, even though a two-wire I²C slave device can recognize the first two bits as address bits because they use the S-clock signal for the bit clock, the one-wire slave device in an I²C environment would not be able to discern such and it could interpret, for example, an address with an address having the logic state “110xxxx” wherein the first two MSBs are “11” as being a single logic one and set the clock at a much lower rate than is actually present. Further, if the first two MSBs were a “00” followed by a “1” the one-wire slave would wait until the third MSB to initiate a determination of the clock duration. As such, the first two MSBs in this system would be lost to unique addresses overall slave devices. Thus, for a 7-bit address scheme with one direction bit but requiring a preamble and a post amble, there would only be eight unique addresses and, as such, there can either be eight one-wire devices with Read/Write capability, eight one-wire devices with Read direction only and sixteen with Write direction only or a combination of the one-wire devices with the I²C devices for the slaves.

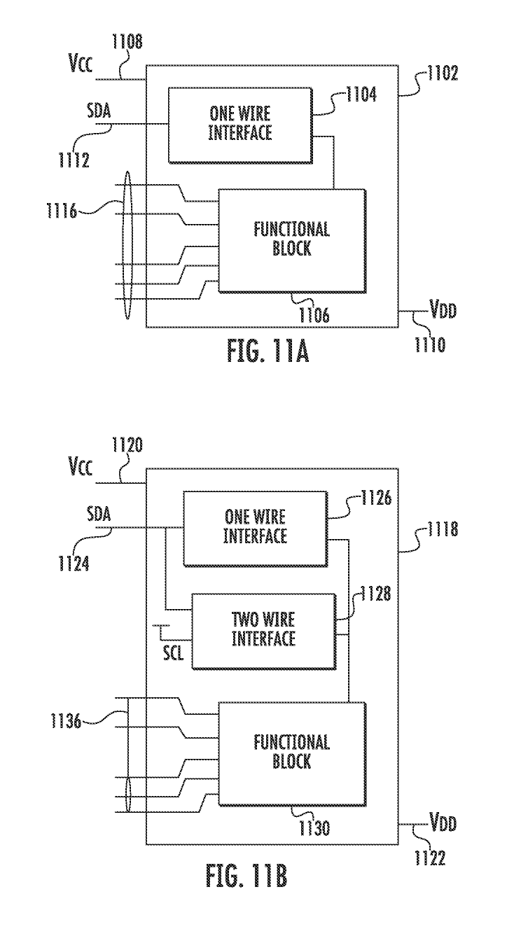

Referring now to FIGS. 11A and 11B there are illustrated two embodiments for the configuration of a packaged chip. Each chip or integrated circuit will have packaged in an integrated circuit package a die that is bonded out to certain pins. The use of a pin for any function in a small pin count package presents an issue and by using the one-wire feature for an I²C interface, this saves one pin in a small pin count package.

With reference to FIG. 11A there is illustrated an integrated circuit package 1102 having eight pins associated therewith. There is provided a power supply pin 1108 for receiving a power supply voltage V_{CC} and a ground or reference pin 1110 for receiving a V_{DD} or drain voltage as a reference voltage. These are conventional power supply inputs for a particular chip, such that at least two pins will be associated with the power supply function. There will be a single data pin 1112 for connection to the SDA wire of an I²C bus. Internal to the chip and on the die will be provided a functional block 1106. This functional block 1106 can be any type of function that requires a data interface to the bus. It could be a DAC, an ADC or an RTC. A one-wire interface 1104 allows the functional block 1106 to communication with the bus and, internal thereto and associated with a functional block 1106 is an address that is unique. In this manner, a master can communicate with the functional block 1106. The functional block 1106 then has five pins 1116 left to allow for its functional interface to the exterior of the integrated circuit package 1102.

Referring now to FIG. 11B, there is illustrated a second embodiment illustrating an integrated circuit package 1118. This package, as was the case with the integrated circuit package 1102, includes multiple pins, these illustrated as being eight pins. A first pin 1120 is associated with the power supply voltage V_{CC}, the higher supply voltage compared to a reference voltage V_{DD} or ground which is connected to a pin 1122. An SDA input for the data connection to the I²C bus is provided on a pin 1124. The remaining five pins 1136 are associated with the functional aspects. The integrated circuit 1118 contains therein a functional block 1130. This could be identical to the functional block 1106 or some other functional block that interfaces to the exterior of the package 1118 through the pins 1136. In order for a functional block 1130 to communicate with the I²C bus, there are provided two interfaces on the die. One is a two-wire interface 1128, which is conventional, and a one-wire interface 1126. Both of these exist on the die such that the die has the ability to either directly interface with the I²C bus in a synchronous manner or it can only interface through a single pin to the SDA data line on the bus. During the bound-out of the die, the SCL pad, which is a one of multiple bond-out pads on a given die, will be connected to a high voltage or disabled. There are many ways to do this. Thereafter, only the data pad associated with the I²C interface is bonded out. Interfaces 1128 and 1126 are provided such that the die can be utilized in multiple different package configurations. It may be that other functions associated with functional block 1130 are also available on the die but they are also not bonded out. This allows for a higher functionality die to be utilized in different packages and, if an additional pin is provided for the clock line, the SDL output of the two-wire interface 1128 can be bonded out and the a system interface with a two-wire bus in a normal. The SCL line in unbonded.

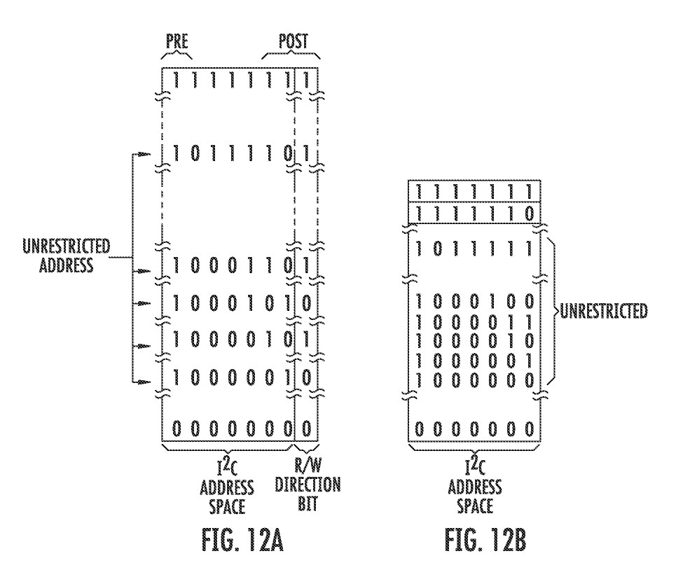

Referring now to FIGS. 12A and 12B, there are illustrated address maps for the I²C system utilizing a one-wire protocol, i.e., an I²C system in which at least one of the slave devices is operating with no clock input. From the perspective of the master in the I²C network, it merely requires knowledge of the address of the particular slave device it wishes to communicate with. It then generates a conventional I²C communication data stream comprised of a start bit (utilizing both the SDA and the SCL lines), a seven-bit address (or a 10-bit address I²C system), a direction bit followed by transferring or receiving data from the slave. Thus, the master does not care nor is even aware that there is a slave device out there that does not have access to an SCL line. In fact, the entire bus may be a one-wire bus with only an SDA line and no clock line at all wherein all of the devices that operate as slaves in a network are one-wire slaves, but the master will operates in accordance with the I²C protocol.

In the situation wherein at least one of the slave devices does not have access to the SCL line and thus must communicate with the one-wire protocol, then the address space for the entire system is restricted such that the first two MSBs are at a logic state “10.” When a system designer designs the system in which at least one slave device does not have access to the SCL line, it will be necessary to ensure that the slave devices are configured so that there is no overlapping of addresses in the address space. Further, in the event that there is a device that can be read from or written to, it is necessary to configure the master such that it perceives this single virtual slave device as being two slave devices by combining two addresses. Since the master views the unique address as defined by the 7-bit address space and a one-wire slave device can have two different I²C addresses in that space, i.e., “10xxx01”, the master must be programmed to consider a single slave device as two separate virtual devices.

Referring specifically to FIG. 12A, there is illustrated the embodiment wherein there is provided the two bit preamble and the three bit post amble for the purpose of synchronization. This is the situation where, as described hereinabove, synchronization is required initially to synchronize the clock for sampling subsequent address bits at the appropriate time within the center of the bit to decode the address and the second synchronization operation is performed prior to transmission of data to ensure that the clock is synchronized prior to data transmission. Therefore, it can be seen that the initial bit sequence “00000000” represents eight bits comprised of the lowermost 7-bit I²C address in the I²C address space and the R/W direction bit. This 7-bit address space must first be restricted to the set of all bit sequences in the address/direction bit sequence of “10xxxxx(x).” Thereafter, since there is a post amble, the last two bits of the 7-bit I²C address space need to be restricted further to the bit sequence “10” and “01.” By adding the “0” or “1” direction bit at the end thereof defines whether this is a Read or Write operation from the perspective of the master operating under the I²C protocol. As noted hereinabove, the slave determines the direction from the A1 bit of the 7-bit I²C address. So, it can be seen that a particular I²C slave device with the unique 7-bit I²C address of “1000001” or “1000010” can be accessed by the master. The system designer configures the master to think that this particular device is two separate virtual devices on the bus, one for a Read and one for a Write. The master accesses the first “virtual” device with the 7-bit address “1000001” and the second “virtual” device with the 7-bit address “1000010.” The addition of a Write or Read bit to the virtual addresses results in the unique addresses of “1000001(0)” and “1000010(1)” so then the master will address one “virtual” device with one address for a Write operation and one “virtual” device for a Read operation wherein, in fact, they are both the single physical device on the bus. As noted hereinabove, the designer could actually place two parts on the system bus, one being a Read only part and one being a Write only part and utilize these specific addresses for the two different devices. Depending upon standards that may be derived for this one-wire configuration, it may be that a particular physical device is limited to the three bit address so that there is no confusion.

FIG. 12B illustrates the embodiment wherein the post amble is not required. In this configuration, all that is required is that the two MSBs of the transmitted address of the I²C address within the 7-bit I²C address space be a logic “10.” As such, all addresses above or below these addresses will be restricted space. With the address “1000000” being the first unrestricted address and the address “1011111” being the top unrestricted address. No synchronization after the three address bits in the I²C address position A4, A3 and A2 is required in this configuration and, thus, the R/W direction bit will operate in accordance with the normal Read/Write operation at the slave. Note hereinabove that, when the master utilizing a preamble and a post amble synchronization process wants to address the device “10000xx(x)”, it will know that the I²C address “1000001” is associated with the Write operation and will set the direction bit to “0” and for a Read operation for that physical device, the master will think it is a different device for the I²C address “1000010” and it will interpret that address device as being a Read only part and will set the direction bit to “1” for a Read operation. The one-wire slave in this I²C network has to extract the clock from the I²C address space and recognize its 3-bit unique one-wire address as well as determine if the operation is a Read or Write operation.

It will be appreciated by those skilled in the art having the benefit of this disclosure that this system and method for operating an I²C using both a two-wire protocol and a one-wire bus provides more flexible uses for devices operation on an I²C bus. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A method for transmitting data on a data line of a two-wire bus including the data line and a clock line, comprising:
pulling the data line low;
transmitting a first group of fixed data bits enabling a slave device to determine a clock signal for an address portion of a transmission of data between a master device and the slave device;
transmitting an address of the slave device in a second group of data bits; and
transmitting a third group of fixed data bits enabling the slave device to determine the clock signal for a data portion of the transmission of data between the master device and the slave device.

2. The method of claim 1, further including:
detecting the data line going low;
detecting the first group of fixed data bits;
generating the clock signal for the address portion of the transmission responsive to the detected first group of fixed data bits;
detecting the address of the slave device addressed by the address portion of the transmission;
detecting the third group of fixed data bits; and
generating the clock signal for the data portion of the transmission responsive to the detected third group of fixed data bits.

3. The method of claim 2, wherein the step of generating a clock signal for the address portion of the transmission further includes:
detecting a first edge of a signal on the data line of the two-wire bus;
initiating a counter responsive to the first edge;
detecting a second edge of the signal on the data line;
stopping the counter responsive to the second edge; and
generating the clock signal for the address portion of the transmission responsive to a value measured by the counter between the first edge and the second edge and an internal clock signal.

4. The method of claim 3, wherein the step of generating a clock signal for the data portion of the transmission further includes:
detecting a third edge of a signal on the data line of the two-wire bus;
initiating a counter responsive to the third edge;
detecting a fourth edge of the signal on the data line;
stopping the counter responsive to the fourth edge; and
generating the clock signal for the address portion of the transmission responsive to a value measured by the counter between the third edge and the fourth edge and an internal clock signal.

5. The method of claim 1, wherein the step of transmitting the third group of fixed data bits further includes the step of transmitting a first configuration of the third group of fixed data bits for a write operation.

6. The method of claim 5, wherein the step of transmitting the third group of fixed data bits further includes the step of transmitting a second configuration of the third group of fixed data bits for a Read operation.

7. An integrated circuit device, comprising:
an interface for connecting the integrated circuit device with a two-wire bus, the two-wire bus including a data line and a clock line;
communications circuitry for performing Read operations and Write operations over the two-wire bus; and
wherein the communications circuitry is configured to operate in a first mode of operation over the two-wire bus using a two-wire communications protocol and to operate in a second mode of operation over the data line of the two-wire bus using a single wire communications protocol.

8. The integrated circuit of claim 7, wherein the communications circuitry is further configured to transmit a first group of fixed data bits enabling a slave device to determine a clock signal for an address portion of a transmission of data between a master device and the slave device in a first portion of an address byte, transmit an address of the slave device in a second group of data bits in a second portion of the address byte and transmit a third group of fixed data bits enabling the slave device to determine the clock signal for a data portion of the transmission of data between the master device and the slave device.

9. The integrated circuit of claim 8, wherein the communications circuitry is further configured to detect the data line going low, detect the first group of fixed data bits, generate the clock signal for the address portion of the transmission responsive to the detected first group of fixed data bits, detect the address of the slave device addressed by the address portion of the transmission, detect the third group of fixed data bits and generate a clock signal for the data portion of the transmission responsive to the detected third group of fixed data bits.

10. The integrated circuit of claim 7, wherein the communications circuitry is configured to detect first and second edges of a signal on the data line of the two-wire bus.

11. The integrated circuit of claim 10, further including:
a clock for generating a timing signal;
a counter for counting a period of time between a rising edge of the first edge of the signal on the data line of the two-wire bus and the second edge of the signal on the data line of the two-wire bus; and
wherein the communications circuitry is further configured to determine a clock signal for the one-wire communications protocol responsive to the timing signal and the counted period of time.

12. The integrated circuit of claim 7, wherein the two-wire bus comprises and I²C bus.

13. A data stream for a one-wire protocol used on a two-wire communications bus including a data line and a clock line, comprising:
an address portion for addressing a slave device from a master device, the address portion further including:
a first group of fixed data bits enabling the slave device to determine a clock signal for the address portion of a transmission of data between the master device and the slave device;
a second group of data bits including an address of the slave device;
a third group of fixed data bits enabling the slave device to determine the clock signal for a data portion of the transmission of data between the master device and the slave device; and
a data portion including the data to be communicated between the master device and the slave device.

14. The data stream of claim 13, wherein the first group of fixed data bits further comprises a two bit data field including a one bit followed by a zero bit.

15. The data stream of claim 13, wherein the second group of data bits further comprises a three bit data field for addressing eight slave device locations.

16. The data stream of claim 13, wherein the third group of fixed data bits further comprises a three bit data field having a first configuration including a 010 bit combination for a write operation and a second configuration including a 101 bit combination for a Read operation.

17. A system, comprising:
a two-wire communications bus including a data line and a clock line;
a master device, the master device including:
a first interface for connecting with the two-wire bus communications bus;
first communications circuitry for performing Read operations and Write operations over the two-wire bus; and
wherein the first communications circuitry is configured to operate in a first mode of operation over the two-wire bus using a synchronous communications protocol and to operate in a second mode of operation over only the data line of the two-wire bus using an asynchronous communications protocol;
a slave device, the slave device including:
a second interface for connecting with the two-wire bus communications bus;
second communications circuitry for performing Read operations and Write operations over the two-wire bus; and
wherein the second communications circuitry is configured to operate in the first mode of operation over the two-wire bus using the synchronous communications protocol and to operate in the second mode of operation over only the data line of the two-wire bus using the asynchronous communications protocol.

18. The system of claim 17, wherein the first and second communications circuitries are further configured to transmit a preamble enabling a slave device to determine a clock signal for an address portion of a transmission of data between the master device and the slave device in a first portion of an address byte, transmit an address of the slave device in a second portion of the address byte and transmit a postamble enabling the slave device to determine the clock signal for a data portion of the transmission of data between the master device and the slave device.

19. The system of claim 18, wherein the first and second communications circuitries are further configured to detect the data line going low, detect the preamble, generate the clock signal for the address portion of the transmission responsive to the detected preamble, detect the address of the slave device addressed by the address portion of the transmission, detect the postamble and generate a clock signal for the data portion of the transmission responsive to the detected preamble.

20. The system of claim 17, wherein the two-wire bus comprises and I²C bus.

21. A slave receiver for operating in a network based on a two wire network protocol requiring one data line carrying data and one clock line carrying data clock information, comprising:
a data input/output interfacable with the data line and receiving a serial data stream synchronized to the data clock information on the clock line generated by a master on the bus, the serial data stream including an address field;
an internal data clock generator for extracting timing information from the address field of the serial data stream and generating a slave data clock synchronized to the serial data stream;
an address decoder for decoding a slave address from the received address field; and
a data read/write interface for receiving serial data from the data input/output generated by the master in a Write operation and transmitting serial data to the master through the data input/output.

22. The slave receiver of claim 21, wherein the address field has a bit length greater than that of the slave address.

23. The slave receiver of claim 22, wherein the address field includes at least two successive rising/falling or falling/rising edges in the serial data stream that are associated with operation of the internal data clock generator and timing information extraction operation thereof, and wherein the slave address portion of the address field lies outside of such least two successive rising/falling or falling/rising edges in the serial data stream

24. The slave receiver of claim 21, wherein address field has at least two predetermined data edges defining timing information within the address field separate from the slave address and the internal data clock generator includes:
an internal slave clock generating an internal slave clock signal having a frequency higher than the clock frequency of the data clock;
a counter for counting a number of cycles of the internal clock between the at least two predetermined data edges to define the length of a cycle of the data clock relative to a cycle of the internal clock; and
a data clock referenced to an initial data edge in the received address field with cycle width defined by the counter.

25. The slave receiver of claim 24 wherein the at least two predetermined data edges occur in the first portion of the address field prior to the address field and the internal data clock generator further extracting additional timing information from the address field after the address decoder has decoded the slave address and resynchronizing the slave data clock prior to receiving or transmitting data.
